(19) United States
(12) Patent Application Publication
(10) Pub. No.: US 2012/0119956 A1
(43) Pub. Date: May 17, 2012

(54) Antenna Device

(75) Inventors: Yen-Yu Chen, Chung Ho City, Taipei Hsien (TW); Hsuan-Yi Chen, Chung Ho City (TW); Hsueh-Min Lin, Chung Ho City (TW); Kuo-Ying Su, Chung Ho City (TW)

(73) Assignee: AVERMEDIA TECHNOLOGIES, INC, Chung Ho City (TW)

(21) Appl. No.: 12/946,025

(22) Filed: Nov. 15, 2010

(51) Int. Cl. H01Q 1/24

(52) U.S. Cl. 343/702

(57) ABSTRACT

A DTV receiving antenna device includes a case, a DTV receiving antenna. The case includes a top cover and a bottom cover. The antenna is situated in the case, including a metal conductor, a circuit board, a matching circuit and a conductive line. The metal conductor is disposed into the top cover. The circuit board is disposed into the bottom cover and includes a ground layer. The matching layer is formed on the circuit board, including a first metal part and a second metal part and a capacitance. The second metal part has a signal feeding point, and there is a gap formed between the first metal part and the second metal part. The capacitance is disposed on the gap and electrically connected to the first metal part and the second metal part. The conductive line is electrically connected to the first metal part and the metal conductor disposed into the top cover.

### BACKGROUND

1. Field of Invention

The present invention relates to an antenna device. More particularly, the present invention relates to a DTV (digital television) antenna device.

2. Description of Related Art

With the progress of the technology, the application of the communication technology is transformed from the wired communication to the wireless communication. The transmission medium is also transformed from the metal wire (for example cable) to the air. Moreover, the antenna plays an important role in the wireless communication device for receiving the electromagnetic wave signal.

The built-in antenna of the common DTV product is a rod antenna and connected to the circuit board by a connector. However, the rod antenna can not receive the DTV signal which is between 470 MHz to 870 MHz perfectly because the impedance bandwidth of the rod antenna can not cover all of the frequency band of DTV (470 MHz to 870 MHz). In the usage of the rod antenna, it is inconvenient that the antenna must be rotated and pulled up first. Moreover, the connector will lose friction easily due to the fatigue of the connector after a long term usage and the antenna will be difficult to positioned at a desired position.

Hence, it is important to provide a better antenna device which could receive signal cover the frequency band of DTV.

### SUMMARY

In accordance with the foregoing and other objectives of the present invention, an antenna device is provided. The antenna device could align the impedance matching by adjusting the cover to increase the efficiency and quality of the receiving of the antenna.

The antennal device comprises a case and an antenna. The case comprises a top cover and a bottom cover. The antenna is set in the case and comprises a metal conductor, a circuit board, a matching circuit and a conductive line. The metal conductor is set in the top cover. The circuit board is set in the bottom cover and comprised a ground layer. The matching circuit is formed on the circuit board and comprised a first metal part, a second metal part and a capacitor. The second metal part has a signal feeding point. There is a gap between the second metal part and the first metal part. The capacitor is set on the gap and electrically connected to the first metal part and the second metal part. The conductive line is electrically connected to the first metal part and the metal conductor of the top cover.

According to one embodiment of the invention, wherein the signal feeding point is used for receiving the frequency band of the DTV between 470 MHz to 870 MHz.

According to one embodiment of the invention, wherein the case further comprises a hinge connecting the top cover and the bottom cover.

According to one embodiment of the invention, wherein the antenna further comprises a metal rotary shaft. The metal rotary shaft is electrically connected to the metal conductor and the ground layer.

According to one embodiment of the invention, wherein the metal conductor is a rectangular shape.

According to one embodiment of the invention, wherein the capacitor is a chip capacitor. The capacitance of the capacitor is between 1 pF and 2 pF.

According to one embodiment of the invention, wherein the first metal part and the second metal part are the print metal layout of the circuit board.

According to one embodiment of the invention, wherein the first metal part is a circular shape, the second metal part is a rectangular shape.

According to one embodiment of the invention, wherein the conductive line comprises a first end and a second end. The first end and the second end are electrically connected to the metal conductor and the first metal part separately. The first end and the second end are circular shapes.

According to one embodiment of the invention, the antenna device further comprises at least one communication module formed on the circuit board.

According to one embodiment of the invention, the antenna device further comprises a slotline set on the metal conductor. The capacitance of the capacitor is over 50 pF.

An antenna device is also provided herein. The antennal device comprises a case, an antenna. The case comprises a top cover and a bottom cover. The antenna is set in the case and comprises a metal conductor, a circuit board, a matching circuit and a conductive line. The metal conductor is set in the top cover. The circuit board is set in the bottom cover and comprised a ground layer. The matching circuit is formed on the circuit board and comprised a first metal part, a second metal part and a capacitor. The second metal part has a signal feeding point. There is a gap between the second metal part and the first metal part. The capacitor is set on the gap and electrically connected to the first metal part and the second metal part. The conductive line is electrically connected to the first metal part and the metal conductor of the top cover. In addition, the antenna device further comprises two parallel metal plates are set on the opposite face of the circuit board. A plurality of metal spring plate is set between the circuit board and the parallel metal plates. The plurality of metal spring plate is used for connecting to the circuit and the parallel metal plates.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A illustrates a top view of an antenna device of one embodiment.

FIG. 1B illustrates a side view of the antenna device in the FIG. 1A.

FIG. 1C illustrates a matching circuit of the antenna device in the FIG. 1A.

FIG. 1D illustrates a conductive line of the antenna device in the FIG. 1A.

FIG. 2 is a S₁₁ diagram of the antenna device in FIG. 1A, wherein the included angle θ of the antenna device is 90 degrees.

FIG. 3 is a S₁₁ diagram of the antenna device in FIG. 1A, wherein the included angle θ of the antenna device is 150 degrees.

FIG. 4 illustrates a top view of the antenna device of one embodiment.

FIG. 5 is a S₁₁ diagram of the antenna device in FIG. 4, wherein the included angle θ of the antenna device is 150 degrees.

FIG. 6A illustrates a top view of a circuit board of an antenna device of one embodiment.

FIG. 6B illustrates a side view of the circuit board of the antenna device in FIG. 6A.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

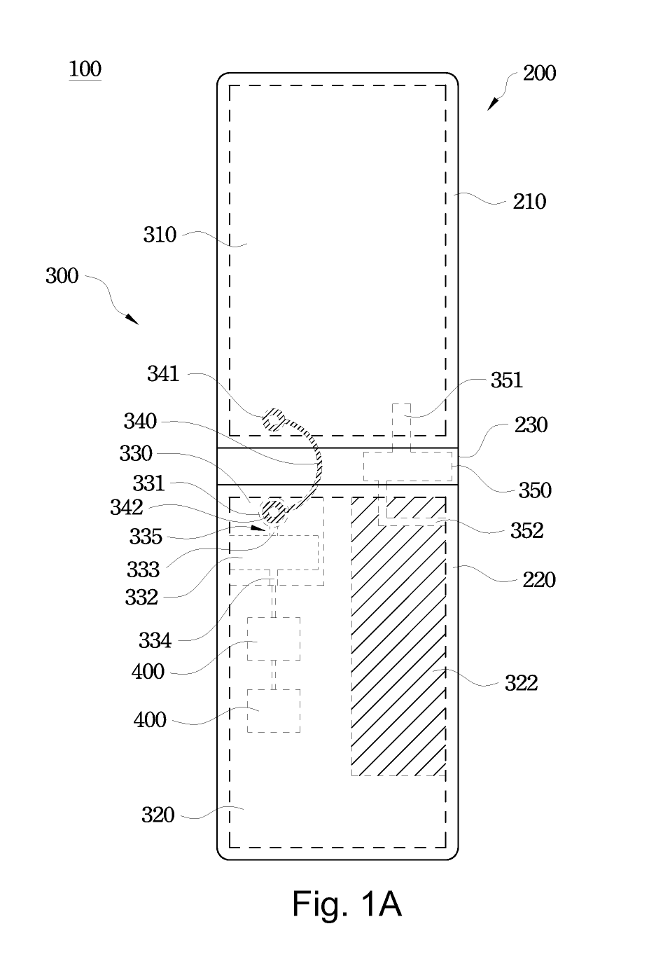

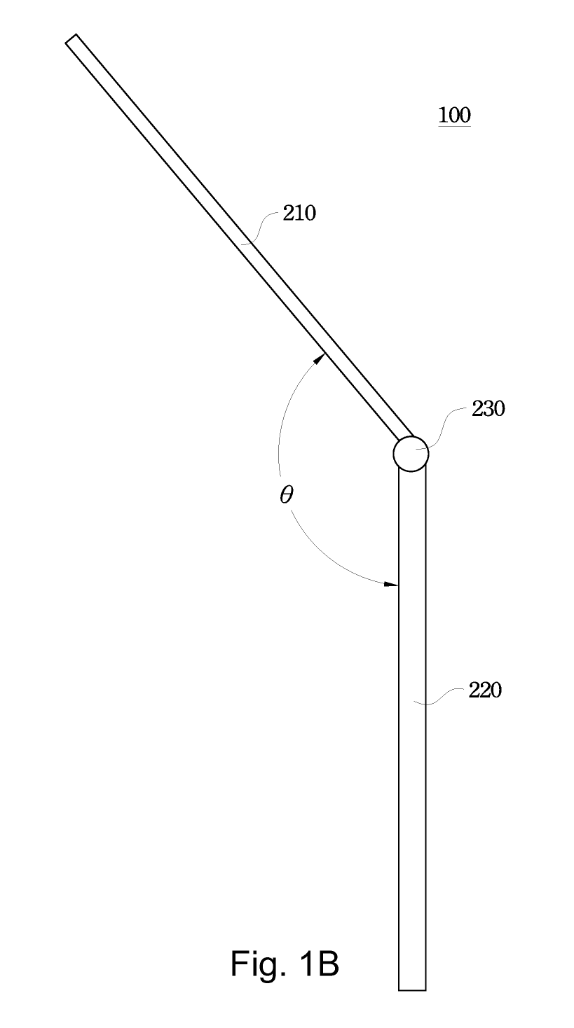

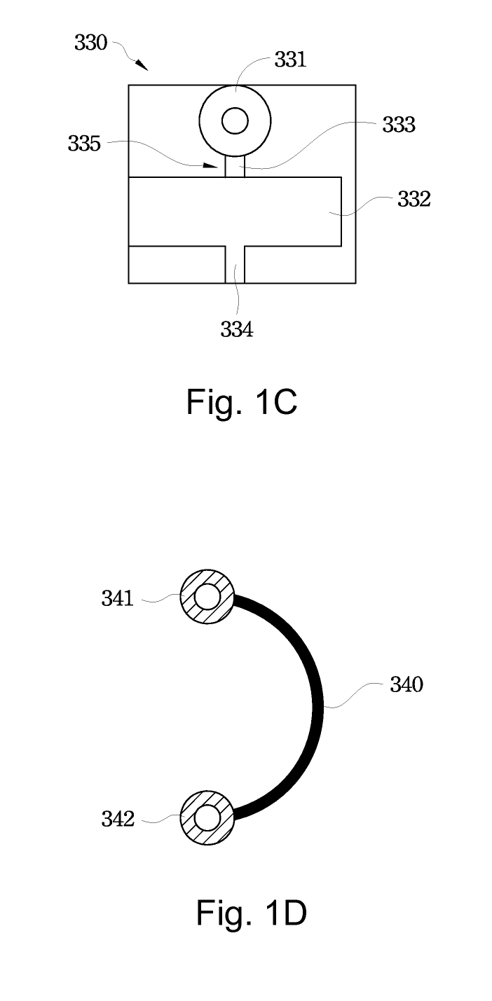

Please refer to FIG. 1A, which illustrates a top view of an antenna device of one embodiment. The antenna device 100 comprises a case 200 and an antenna 300. The case 200 comprises a top cover 210 and a bottom cover 220. The antenna 300 is set in the case 200. The antenna 300 comprises a metal conductor 310, a circuit board 320, a matching circuit 330 and a conductive line 340. However, the antenna 300 is an inner component of the antenna device 100 so that the antenna 300 is illustrated with a dotted line in FIG. 1A.

The metal conductor 310 is set in the top cover 210. The circuit board 320 is set in the bottom cover 220 and has a ground layer 322. The matching circuit 330 is formed on the circuit board 320 and comprises a first metal part 331, a second metal part 332 and a capacitor 333. The second metal part 332 has a signal feeding point 334. Moreover, there is a gap formed between the second metal part 332 and the first metal part 331. The capacitor 333 is set on the gap 335 and electrically connected to the first metal part 331 and the second metal part 332. The conductive line 340 is electrically connected to the first metal part 331 and the metal conductor 310.

In addition, the antenna 300 receives the DTV signal by the metal conductor 310. The frequency band of DTV is between 470 MHz to 870 MHz. Then, the signal is transmitted to the matching circuit 330 by the conductive line 340. Therefore, the operation bandwidth of the antenna 300 is increased. The antenna device 100 could receive the DTV signal more perfectly.

In one embodiment, the metal conductor 310 is a rectangular shape and shown in FIG. 1A. The size of the metal conductor 310 is 9 cm×5.4 cm in this embodiment. However, the shape of the metal conductor 310 is not limited herein. The shape of the metal conductor 310 also can be a polygon to increase the design flexibility.

Please refer to FIG. 1A and FIG. 1B together, FIG. 1B illustrates a side view of the antenna device in the FIG. 1A. The case 200 further comprises a hinge 230 connecting the top cover and the bottom cover. Therefore, an included angle θ is formed between the top cover 210 and the bottom cover 220. The range of the included angle θ is 0 degrees to 180 degrees. Hence, the connection by the hinge 230 could provide a degree of freedom for rotating. In other words, the included angle θ could be changed to adjust the matching of the antenna 300. Therefore, the radiation pattern and the radiation efficiency could be improved. Moreover, the hinge 230 could be designed for fixing the top cover 210 and the bottom cover 220 with a specific included angle, such as the included angle θ is 90 degrees or 150 degrees.

In addition, the antenna 300 further comprises a metal rotary shaft 350 set in the hinge 230. The metal rotary shaft 350 is connected to the metal conductor 310 and the ground layer 332. The metal rotary shaft 350 further comprises a first connected portion 351 and a second connected portion 352. The first connected portion 351 and the second connected portion 352 are connected to the metal conductor 310 and the ground layer 332 separately. Moreover, the ground layer 331 is formed on the circuit board 320 in this embodiment. However, the ground layer 332 also can be set in the inner layer or the bottom face of the circuit board 320.

Please refer to FIG. 1A and FIG. 1C, wherein FIG. 1C illustrates the matching circuit 330 of the antenna device in the FIG. 1A. The first metal part 331, the second metal part 332 and the signal feeding point 334 are made of a metal material. Other space is a medium. In one embodiment, the first metal part 331 and the second metal part 332 are the printed metal layout of the circuit board 320. However, the first metal part 331 and the second metal part 332 also could be formed on the circuit board by the etching technology. In another embodiment, the first metal part 331 is a circular shape, and the second metal part 332 is a rectangular shape. Moreover, the second metal part 332 could be changed the shape and the size of area to satisfy the impedance matching.

In addition, the capacitor 333 set on the gap 335 is a chip capacitor in one embodiment. The capacitor 333 is electrically connected to the first metal part 331 and the second metal part 332, and the capacitance of the capacitor 333 is between 1 pF and 2 pF. It makes the matching circuit 330 having a better impedance matching in the operation frequency band.

Please refer to FIG. 1A and FIG. 1D together, wherein FIG. 1D illustrates a conductive line of the antenna device in the FIG. 1A. In one embodiment, the conductive line 340 comprises a first end 341 and a second end 342. The first end 341 and a second end 342 are electrically connected to the metal conductor 310 and the first metal part 331 separately. The shapes of the first end 341 and the second end 342 are circles. In addition, the second end 342 of the conductive line 340 and the first metal part 331 have the same hole size. Therefore, the second end 342 of the conductive line 340 and the first metal part 331 could mount on the circuit board 320 by a mounting member (not shown in the figure), such as a screw.

Moreover, in one embodiment, the antenna device 100 further comprises at least one communication module 400 formed on the circuit board. The communication module 400 is electrically connected to the signal feeding point 334. Hence, it can watch DTV program when the antenna device 100 is connected to the display device.

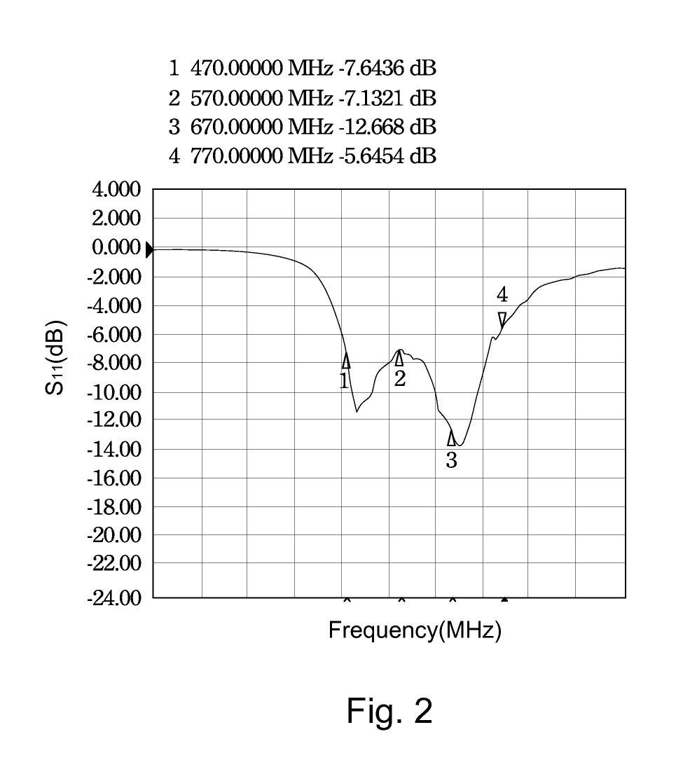

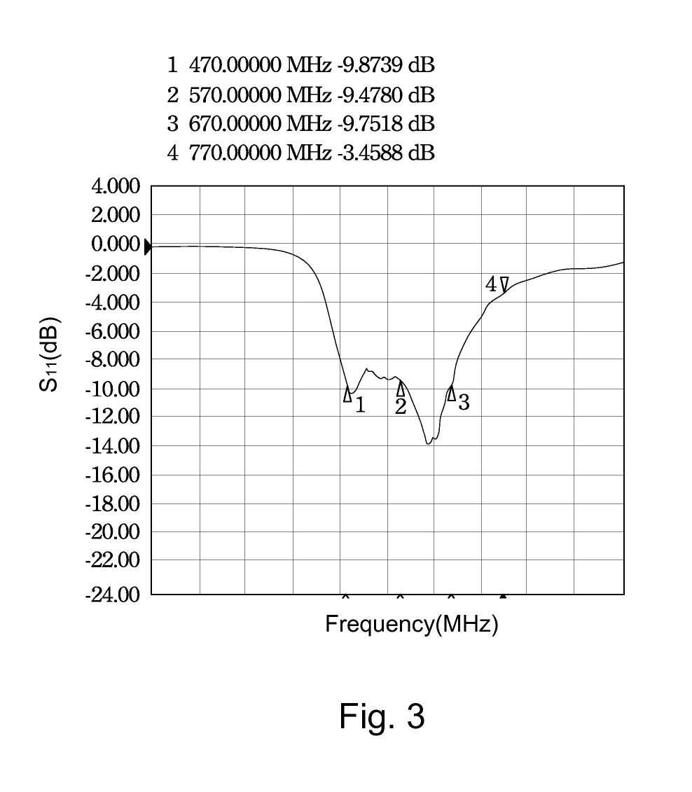

Please refer to FIG. 2 and FIG. 3. FIG. 2 is a S₁₁ diagram of the antenna device in FIG. 1A, wherein the included angle θ of the antenna device is 90 degrees. FIG. 3 is a S₁₁ diagram of the antenna device in FIG. 1A, wherein the included angle θ of the antenna device is 150 degrees. Wherein, the parameter S₁₁ means the return loss. According to the return loss is shown in the diagrams, when the bigger included angle θ between the top cover 210 and the bottom cover 220 is, the receiving frequency band of the antenna 300 will be moved to low frequency. Therefore, the included angle could be changed based on the local DVT signal frequency to increase the radiation efficiency and radiation performance in the signal receiving process.

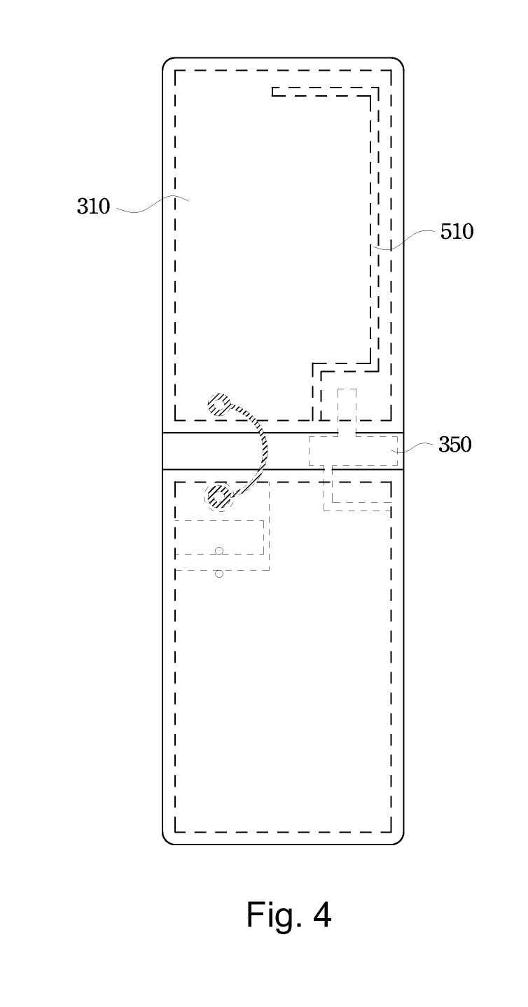

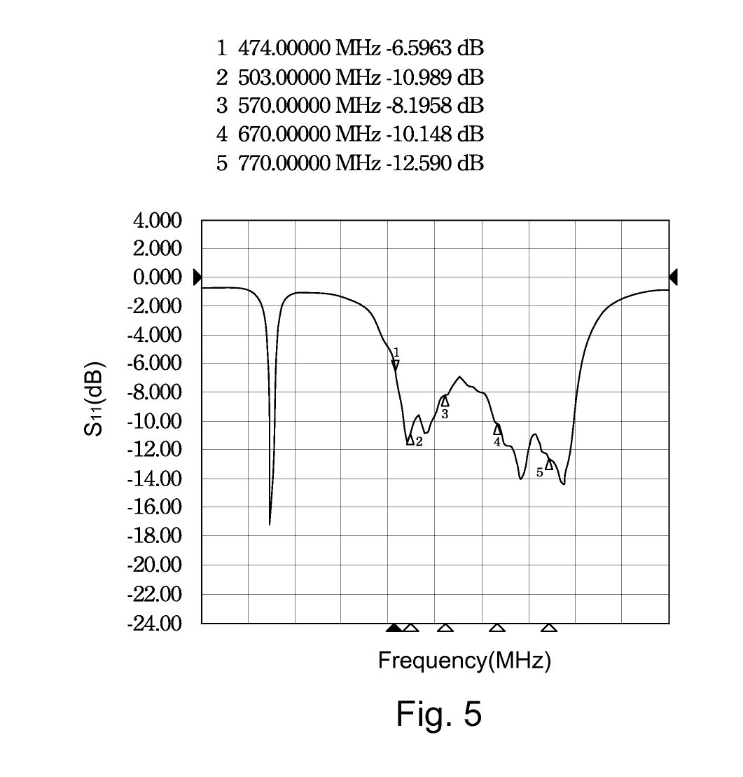

Please refer to FIG. 4. FIG. 4 illustrates a top view of the antenna device of one embodiment. In this embodiment, a slotline 510 is formed on the metal conductor 310. The slotline 510 is another form of the antenna. The capacitance is over 50 pF so that the matching circuit having a better impedance matching in the operation frequency band in this embodiment. Please refer to FIG. 5 together. FIG. 5 is a S₁₁ diagram of the antenna device in FIG. 4, wherein the included angle θ of the antenna device is 150 degrees. In this embodiment, there is a better impedance matching in 470 MHz to 870 MHz than the foregoing embodiment.

In this embodiment, the metal rotary shaft 350 is electrically connected to the metal conductor 310 and the ground layer. Moreover, besides the slotline 510, the metal rotary shaft 350 can be electrically connected to the metal conductor and without electrically connect to the ground layer in other embodiment. In addition, the capacitance is still designed over 50 pF. However, the capacitance could be changed to get best impedance matching based on the different situations.

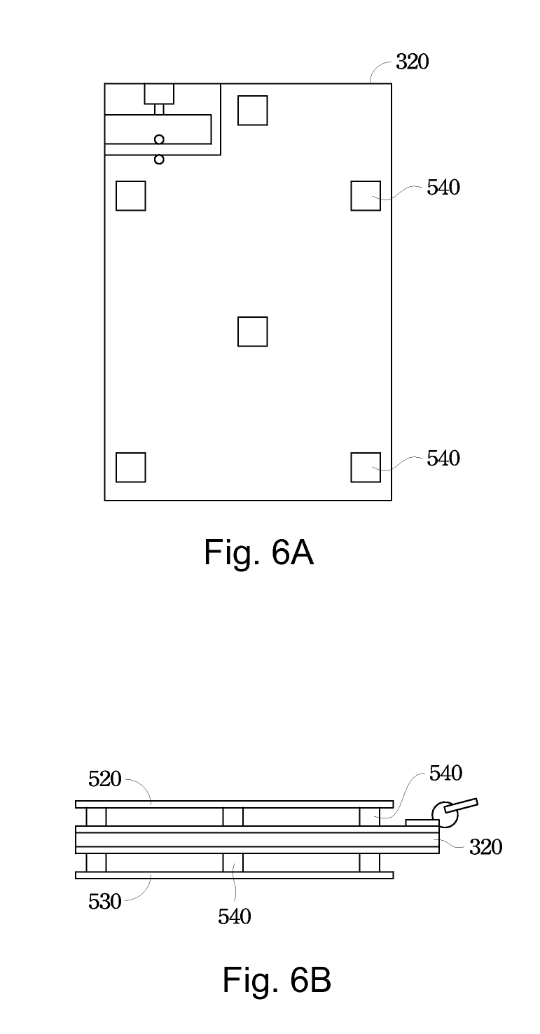

Please refer to FIG. 6A and FIG. 6B together. FIG. 6A illustrates a top view of a circuit board of an antenna device of one embodiment. FIG. 6B illustrates a side view of the circuit board of the antenna device in FIG. 6A. In order to improve the signal reception, the first parallel metal plate 520 and second parallel metal plate 530 are set in parallel on the up and down sides of the circuit board 320 separately. There are a plurality of metal spring plates 540 set between the parallel metal plates 520, 530 and circuit board 320. The metal spring plates 540 are used for connecting the parallel metal plates 520, 530 and circuit board 320. The parallel metal plates 520, 530 could isolate the noise from outside and increase the heat dissipation area. Therefore, the signal reception of the antenna device is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An antenna device comprising:
a case comprising a top cover and a bottom cover; and
an antenna configured in the case, comprising:
a metal conductor configured in the top cover;
a circuit board configured in the bottom cover and having a ground layer;
a matching circuit formed on the circuit board, comprising:
a first metal part;
second metal part having a signal feeding point and spaced from the first metal part by a gap;
a capacitor configured on the gap and electrically connected to the first metal part and the second metal part; and
a conductive line electrically connected to the metal conductor and the first metal part.

2. The antenna device of claim 1, wherein the signal feeding point is capable of receiving the frequency band of digital television between 470 MHz to 870 MHz.

3. The antenna device of claim 1, wherein the case further comprises a hinge connecting the top cover and the bottom cover.

4. The antenna device of claim 3, wherein the antenna further comprises a metal rotary shaft disposed in the hinge and electrically connected to the metal conductor and the ground layer.

5. The antenna device of claim 4, wherein the metal conductor further comprises a slotline.

6. The antenna device of claim 5, wherein the capacitor is a chip capacitor and the capacitance of the capacitor is over 50 pF.

7. The antenna device of claim 3, wherein the antenna further comprises a metal rotary shaft disposed in the hinge and electrically connected to the metal conductor.

8. The antenna device of claim 7, wherein the metal conductor further comprises a slot line.

9. The antenna device of claim 8, wherein the capacitor is a chip capacitor and the capacitance of the capacitor is over 50 pF.

10. The antenna device of claim 1, wherein the metal conductor is a rectangular shape.

11. The antenna device of claim 1, wherein the capacitor is a chip capacitor and the capacitance of the capacitor is between 1 pF and 2 pF.

12. The antenna device of claim 1, wherein the first metal part and the second metal part are the printed metal layout of the circuit board.

13. The antenna device of claim 1, wherein the first metal part is a circular shape, the second metal part is a rectangular shape.

14. The antenna device of claim 1, wherein the conductive line comprises a first end and a second end, the first end and the second end are electrically connected to the metal conductor and the first metal part separately, and the first end and the second end are circular shapes.

15. The antenna device of claim 1 further comprising at least one communication module formed on the circuit board.

16. An antenna device comprises:
a case comprising a top cover and a bottom cover;
an antenna configured in the case, comprising:
a metal conductor configured in the top cover;
a circuit board configured in the bottom cover and having a ground layer;
a matching circuit formed on the circuit board, comprising:
a first metal part;
a second metal part having a signal feeding point and spaced from the first metal by a gap;
a capacitor configured on the gap and electrically connected to the first metal part and the second metal part;
a conductive line electrically connected to the metal conductor and the first metal part;
two parallel metal plates configured on the opposite face of the circuit board; and
a plurality of metal spring plates configured between the circuit board and the parallel metal plates, and electrically connected to the circuit board and the parallel metal plates.
